(19) United States
(12) Patent Application Publication
(10) Pub. No.: US 2018/0167137 A1
(43) Pub. Date: Jun. 14, 2018

(54) ENABLING COEXISTENCE WITH NARROWBAND WI-FI DEVICES THROUGH DEVICE CLASS DEFINITIONS

(71) Applicant: Intel Corporation, Santa Clara, CA (US)

(72) Inventors: Shahrnaz Azizi, Cupertino, CA (US); Eldad Perahia, Portland, OR (US); Ilan Sutskover, Hadera (IL); Minyoung Park, Portland, OR (US); Thomas J. Kenney, Portland, OR (US)

(21) Appl. No.: 15/373,269

(22) Filed: Dec. 8, 2016

(51) Int. Cl. H04B 7/26; H04W 74/08

(52) U.S. Cl. CPC H04B 7/2656; H04W 84/12; H04W 74/0816

(57) ABSTRACT

Embodiments of a wireless station and method for communicating in a Wi-Fi network in accordance with coexistence techniques are described. The station (STA) can include memory and processing circuitry. The processing circuitry is configured to decode a packet received from a second STA, the packet including an information element (IE) indicating the second STA is one of a hybrid class device or a narrowband (NB) class device. When the IE indicates that the second STA is a hybrid class STA, a hybrid packet is generated for transmission to the second STA. The hybrid packet includes a legacy preamble followed by a narrowband (NB) preamble and a NB payload. When the IE indicates that the second STA is a NB class STA, a NB packet is generated for transmission to the second STA. The NB packet including the NB preamble and the NB payload, and is generated without the legacy preamble.

### TECHNICAL FIELD

Embodiments pertain to wireless networks. Some embodiments relate to wireless local area networks (WLANs), networks and networks operating in accordance with one of the IEEE 802.11 standards, such as the IEEE 802.11ac standard or the IEEE 802.11ax. Some embodiments relate to high-efficiency wireless or high-efficiency WLAN (HEW) communications. Some embodiments relate to enabling coexistence with narrowband (NB) devices through device class definitions.

### BACKGROUND

Wi-Fi communications have been evolving toward ever increasing data rates (e.g., from IEEE 802.11a/g to IEEE 802.11n to IEEE 802.11ac to IEEE 802.11ax). The IEEE 802.11ax is the latest evolution of these standards and is intended to provide an increase in data capacity while maintaining compatibility with previous 802.11 systems. Another recent development in the IEEE 802.11 is enabling low power (LP) data transfer mode for There are general needs in achieving coexistence between LP devices and any legacy IEEE 802.11 devices, including devices operating under one or more of the IEEE 802.11 a/g/n/ac/ax standards.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN with NB and hybrid class devices in accordance with some embodiments;

FIG. 2 illustrates an example usage scenario of a WLAN with NB and hybrid class devices in a user home, in accordance with an example embodiment;

FIG. 3A illustrates a packet structure, which may be used for communication with a NB device within a WLAN, in accordance with an example embodiment;

FIG. 3B illustrates an example wideband preamble, which may be used within the packet structure of FIG. 3A;

FIG. 4 illustrates a Device Coexistence Class (DCC) element format, in accordance with an example embodiment;

FIG. 5 illustrates a wireless communication device in accordance with some embodiments;

FIG. 6 illustrates a flow diagram of an example method for communication between a NB class device and hybrid class device within a WLAN, in accordance with an example embodiment; and

FIG. 7 illustrates a block diagram of an example machine upon which any one or more of the techniques (e.g., methodologies) discussed herein may perform.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

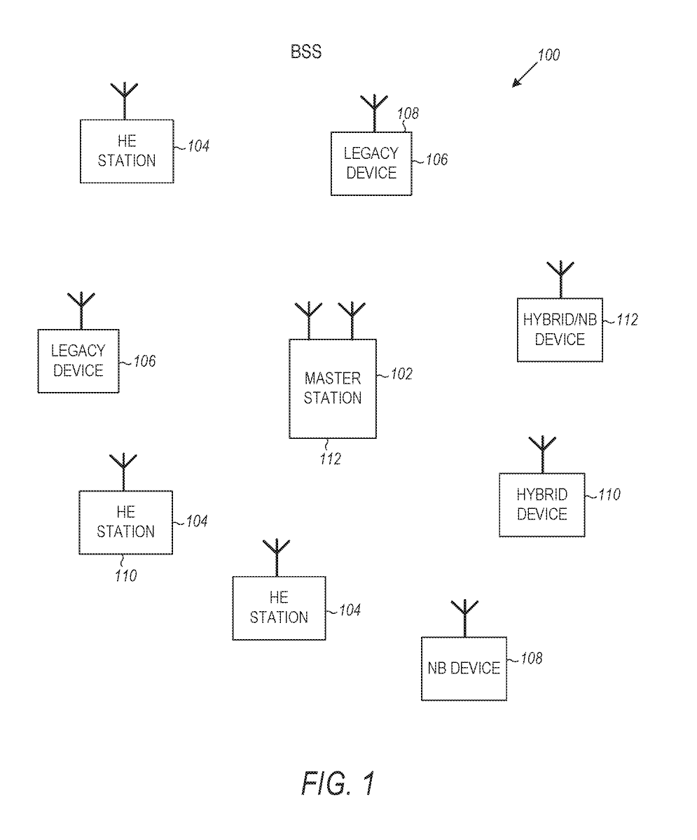

FIG. 1 illustrates a WLAN with NB and hybrid class devices in accordance with some embodiments. The WLAN may comprise a basis service set (BSS) 100 that may include a master station 102, which may be an access point (AP), a plurality of high-efficiency (HE) (e.g., IEEE 802.11ax) stations (STAs) 104, and a plurality of legacy (e.g., IEEE 802.11n/ac) devices 106. The BSS 100 may also include wireless devices of various device classes, such as a narrowband (NB) class wireless device 108, a hybrid class wireless device 110 and a hybrid/NB class wireless device 112. In an example, one or more of the HE STAs 104, the master STA 102 and the legacy devices 106 may be of a device class similar to devices 108, 110 and 112. For example, and as indicated in FIG. 1, one of the HE STAs 104 is also a hybrid device 110, the master STA 102 is also a hybrid/NB device 112, and one of the legacy devices 106 is also a NB device 108.

In an example, one or more of the devices in the BSS 100 may be allowed to operate with a bandwidth smaller than 20 MHz to enable low power (LP) data transfer. The lower bandwidth capable devices may be designated as narrowband (NB) devices (e.g., device 108). The NB devices can include LP Internet-of-Things (IoT) devices (e.g., home sensor devices) or other NB devices.

HE devices (e.g., 104) may operate under OFDMA in smaller bandwidths. However, the NB devices (e.g., 108) may be configured to operate within a bandwidth smaller than 20 MHz, for example approximately 2 MHz to 2.6 MHz. In comparison, in instances when a HE device 108 is configured to transmit in 802.11ax OFDMA modes, a 2 MHz signal can be transmitted but after a legacy preamble is transmitted first at 20 MHz. In some instances, to achieve co-existence between the NB devices and the HE and legacy wireless devices, the NB devices can be configured to transmit a wideband legacy preamble before the NB preamble. However, this solution may be energy intensive for the LP device.

NB communications may be used to meet a given communication range requirement while lowering the transmit power, to enable low power low cost devices (e.g., battery-operated sensor devices). For example, for very low power and non-rechargeable battery operated devices (e.g., a smoke detector), there may be a hard limit on maximum transmit power. If the NB device transmits a wideband preamble followed by a narrowband preamble, limiting the transmit power of the legacy portion of the preamble to be equal to that of the narrowband portion may reduce the protection range obtained from transmission of the legacy preamble. There are usage scenarios where legacy devices exist in coverage area of the AP, and thus coexistence through legacy protection for the full range of coverage is important. However, this solution may be energy intensive for the NB device.

In an example, two different classes of narrowband devices may be defined (e.g., via a device coexistence class (DCC) information element, as illustrated herein below) for narrowband operation in, e.g., 2.4/5 GHz bands. For example, a narrowband (NB) class and a hybrid class of devices may be defined. The hybrid class device may include a device that is configured to transmit a wideband (e.g., 20 MHz) preamble prior to transmitting a NB preamble followed by NB payload. The hybrid device may also be configured to perform 20 MHz clear channel assessment (CCA) prior to transmission of the wideband preamble.

The narrowband (NB) class device may include a device that is configured to operate solely within a narrowband channel (e.g., a bandwidth selected from the range of 2 MHz-2.6 MHz), and can be configured to transmit only NB preamble and NB payload, without first transmitting a wideband preamble. In this regard, a NB class device can rely on a hybrid class device for coexistence with other HE or legacy wireless devices.

The master station 102 may be an AP using one of the IEEE 802.11 protocols to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the I FEE 802.11 protocol may include space-division multiple access (SDMA) and/or multiple-user multiple-input multiple-output (MU-MIMO). The master station 102 and/or HE station 104 may use one or both of MU-MIMO and OFDMA. There may be more than one master station 102 that is part of an extended service set (ESS). A controller (not illustrated) may store information that is common to the more than one master station 102. The controller may have access to an external network such as the Internet,

The legacy devices 106 may operate in accordance with one or more of IEEE 802.11 a/b/g/n/ac/ad/af/ah/aj, or another legacy wireless communication standard. The legacy devices 106 may be STAs or IEEE 802.11 STAs. The HE stations 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.1.1ax or another wireless protocol such as IEEE 802.11az. In some embodiments, the HE stations 104, master station 102, and/or legacy devices 106 may be termed wireless devices. In some embodiments the HE station 104 may be a “group owner” (GO) for peer-to-peer modes of operation where the HE station 104 may perform some operations of a master station 102.

Even though the legacy devices 106 are illustrated as being separate from the HE devices 104, the disclosure is not limited in this regard. In some instances, the term “legacy device” may include devices operating in accordance with one or more of IEEE 802.11 a/b/g/n/ac/ad/af/ah/aj as well as 802.11ax.

The master station 102 may communicate with legacy devices 106 in accordance with legacy IEEE 802.11 communication techniques. In example embodiments, the master station 102 may also be configured to communicate with HE stations 104 in accordance with legacy IEEE 802.11 communication techniques.

In some embodiments, a HE frame may be configurable to have the same bandwidth as a channel. The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the channels may be based on a number of active subcarriers. In some embodiments the bandwidth of the channels can be 26, 52, 106 or 242 active subcarriers or tones that are spaced by 20 MHz. In some embodiments the bandwidth of the channels can be 26, 52, 106, 242, etc. active data subcarriers or tones that are space 20 MHz apart. In some embodiments the bandwidth of the channels is 256 tones spaced by 20 MHz. In some embodiments a 20 MHz channel may comprise 256 tones for a 256 point Fast Fourier Transform (FFT). In some embodiments, a different number of tones is used. In some embodiments, the OFDMA structure consists of a 26-subcarrier resource unit (RU), 52-subcarrier RU, 106-subcarrier RU, 242-subcarrier RU, 484-subcarrier RU and 996-subcarrier RU. Resource allocations for single user (SU) consist of a 242 subcarrier RU, 484-subcarrier RU, 996-subcarrier RU and 2×996-subcarrier RU.

A HE frame may be configured for transmitting a number of spatial streams, which may be in accordance with MU-MIMO. In some embodiments, a HE frame may be configured for transmitting in accordance with one or both of OFDMA and MU-MIMO. In other embodiments, the master station 102, HE station 104, and/or legacy device 106 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, WiMAX, WiGig, or other technologies.

Some embodiments relate to HE communications. In accordance with some IEEE 802.11ax embodiments, a master station 102 may operate as a master station which may be arranged to contend for a wireless medium (e.g., during a contention period) to receive exclusive control of the medium for an HE control period. In some embodiments, the HE control period may be termed a transmission opportunity (TXOP). The master station 102 may transmit a HE master-sync transmission, which may be a trigger frame or HE control and schedule transmission, at the beginning of the HE control period. The master station 102 may transmit a time duration of the TXOP and channel information. During the HE control period, HE stations 104 may communicate with the master station 102 in accordance with a non-contention based multiple access technique such as OFDMA and/or MU-MIMO. This is unlike conventional WLAN communications in which devices communicate in accordance with a contention-based communication technique, rather than a multiple access technique. During the HE control period, the master station 102 may communicate with HE stations 104 using one or more HE frames. During the HE control period, the HE STAs 104 may operate on a channel smaller than the operating range of the master station 102. During the HE control period, legacy stations refrain from communicating.

In accordance with some embodiments, during the master-sync transmission the HE STAs 104 may contend for the wireless medium with the legacy devices 106 being excluded from contending for the wireless medium during the master-sync transmission or TXOP. In some embodiments the trigger frame may indicate an uplink (UL) UL-MU-MIMO and/or UL OFDMA control period. In some embodiments, the trigger frame may indicate a portions of the TXOP that are contention based for some HE station 104 and portions that are not contention based.

In some embodiments, the multiple-access technique used during the HE control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

In example embodiments, the HE device 104, the legacy device 106 and/or the master station 102 can be configured under a device class (e.g., NB, hybrid, or both) to perform the methods and operations herein described in conjunction with FIGS. 1-7.

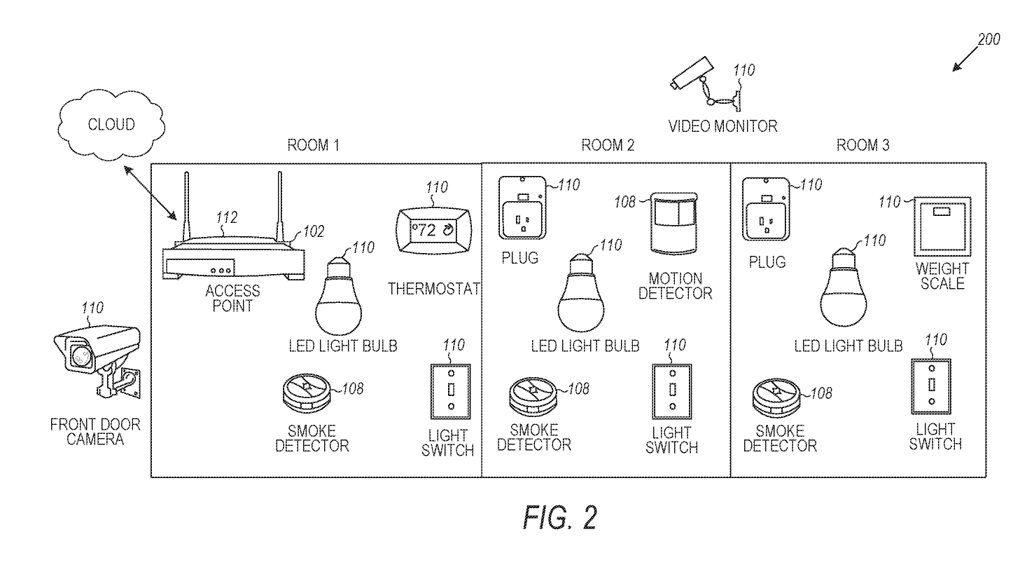

FIG. 2 illustrates an example usage scenario of a WLAN with NB devices in a user home, in accordance with an example embodiment. Referring to FIG. 2, there is illustrated a user home 200, including three rooms (Room 1, Room 2 and Room 3) with various wireless-enabled devices. For example, Room 1 may include the access point (AP) 112, an LED light bulb, a thermostat, a smoke detector and a light switch. Room 2 may include an electric plug, a motion detector, an LED light bulb, a smoke detector and a light switch, Room 3 may include an electric plug, an LED light bulb, a weight scale, a smoke detector and a light switch. A front door camera and a video monitor may be used on the outside of the house as well.

The small battery-operated devices, such as smoke detectors and motion detectors, are low-cost very low power devices. They can be configured to transmit sporadic short packets with short transmit range to a repeater/assisting device (e.g., a hybrid class device) that is plugged into the wall (e.g., a LED light bulb, an electric plug, a light switch, a camera, a thermostat). Since these devices are power and cost limited, these devices can be configured to only transmit and receive narrowband (NB) signals and rely on the repeater/assisting device (e.g., a hybrid device) that can transmit a 20 MHz legacy preamble for coexistence. However, devices such as the weight scale (that has larger battery) or the LED light bulb (which is not battery operated) are capable of prepending their NB transmission with legacy preamble, as well as to perform wideband CCA prior to their transmissions. Therefore, as seen in FIG. 2, the smoke detectors and the motion detectors are referenced as 108 (e.g., a NB class device); and the LED bulb, light switch, electric plug, weight scale, camera/monitor, and thermostat are referenced as 110 (e.g., hybrid class device). The AP 102 can function as both NB and hybrid device and is referenced as 112.

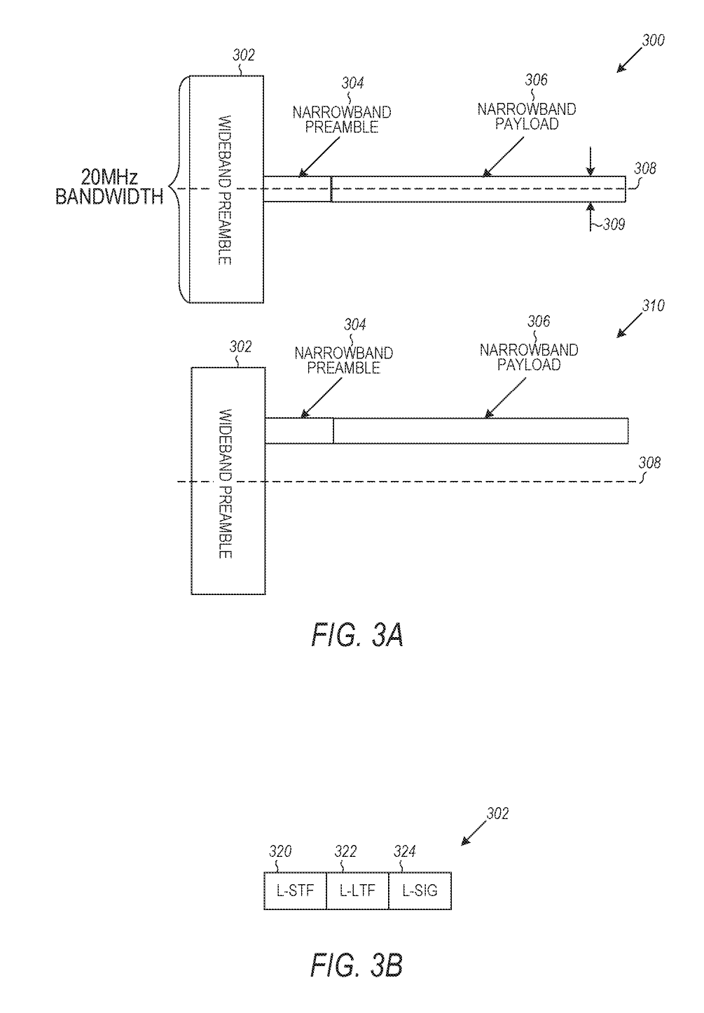

FIG. 3A illustrates a packet structure, which may be used for communication with a NB device within a WLAN, in accordance with an example embodiment. Referring to FIG. 3A, there is illustrated a packet structure 300, which may be communicated by a hybrid device (e.g., 108). More specifically, a wideband preamble 302 may be communicated first (e.g., using a 20 MHz bandwidth), followed by a narrowband preamble 304 and a narrowband payload 306. The bandwidth 309 of the NB preamble 304 and the NB payload 306 may be narrower (e.g., 2 MHz) than the bandwidth used to communicate the wideband preamble 302 (e.g., 20 MHz). In an example, the narrowband preamble 304 and the narrowband payload 306 may share the same center frequency 308 as the wideband preamble 302.

In another example, a packet structure 310 may be used, where the narrowband preamble 304 and the narrowband payload 306 are offset from, and do not share the same center frequency 308 as, the wideband preamble 302.

Two examples of upper and lower limits for bandwidth for narrowband transmissions can be determined as follows:

At the center (packet structure 300): RU 26-tone+7 nulls: (20 MHz/256-FFT)*(26+7)=2.578125 MHz (or approximately 2.6 MHz). Not at the center (for packet structure 310): RU 26-tone: (20 MHz/256-FFT)*(26)=2.03125 MHz.

FIG. 3B illustrates an example wideband preamble, which may be used within the packet structure of FIG. 3A. Referring to FIG. 3B, the legacy (wideband) preamble 302 may include a legacy short training field (L-STF) 320, a legacy long training field (L-LTF) 322, and a legacy signal field (L-SIG) 324.

The L-SIG field 324 may provide information about the data field as far as the coding and modulation (rate) and the length among other parameters. The L-STF 320, L-LTF 322, and L-SIG 324 may be formatted so that they are compatible with legacy devices such as devices that operate in accordance with IEEE 802.11a/g/n/ac/ax.

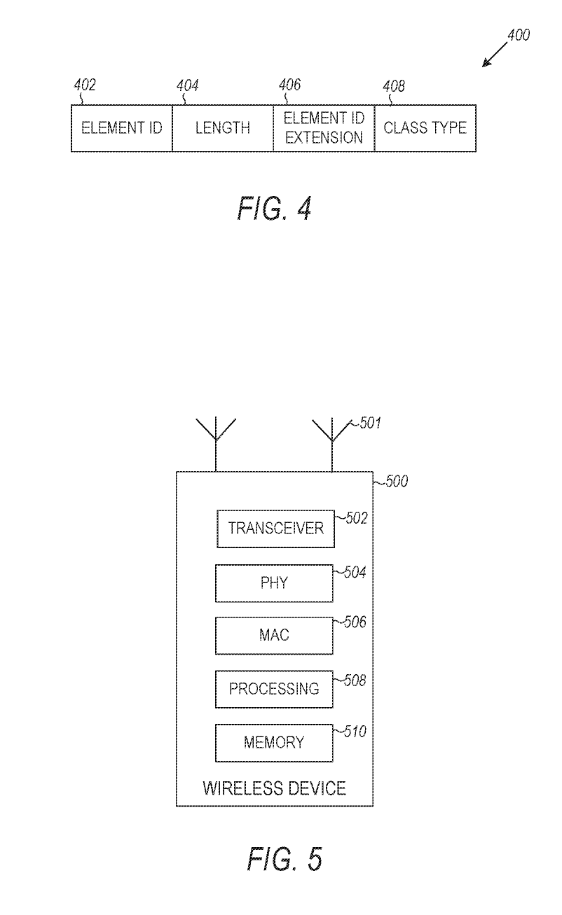

FIG. 4 illustrates a Device Coexistence Class (DCC) element format, in accordance with an example embodiment. Referring to FIG. 4, the DCC information element 400 may include an element identification (ID) field 402, a length field 404, an element ID extension field 406 and a device class type field 408. The element ID field 402 identifies the DCC information element. The length field 404 identifies the length of the DCC 400 after the element ID field 402 and including the class type field 408. The extension field 406 provides an extension of the element ID field 402.

When included in a management frame (e.g., a probe request, an association request and other action frames), the device class type field 408 may indicate the device class type. When included in beacons, probe responses and other action frames, the device class type field may indicate the device classes supported classes by the AP. The device class type field 408 may be set to 1 to indicate a STA supports Class I (e.g., a hybrid device), set to 2 to indicate the STA supports Class II (e.g., a NB device), or set to 3 to indicate the STA supports Class I and II.

In instances when a STA indicates that it is Class II device (i.e. a NB class device such as device 108) during association to an AP or assisting STA that is Class I capable, the AP or assisting STA can be configured to send a trigger frame in the hybrid packet structure (e.g., as illustrated in FIG. 3A) for coexistence. For example, and referring to FIGS. 1 and 2, the smoke detector may indicate in a DCC element that it is a class II device (i.e., a NB class device), the LED light may indicate in a DCC element that it is a class I device (i.e., a hybrid class device). In instances when the smoke detector has information to send to the AP 102, the LED light may function as an assisting/relaying STA. The smoke detector may send a NB packet that includes a NB preamble and NB payload, which may be received by the LED light. The LED light may then send (e.g., to the AP 102) a hybrid packet (e.g., 300) that includes a legacy wideband preamble 302 (for coexistence) followed by the NB preamble and NB payload received from the smoke detector.

FIG. 5 illustrates a wireless communication device in accordance with some embodiments. Wireless device 500 may be a HE compliant device that may be arranged to communicate with one or more other wireless devices, such as HE devices 104 (FIG. 1) or access point 102 (FIG. 1) as well as communicate with legacy devices 106. The HE devices 104, legacy devices 106, and the master station 112 can be a NB-type device (e.g., as device 108), a hybrid-type device (e.g., as device 110) or a hybrid/NB-type device (e.g., as device 112 in FIG. 1). The HE devices 104 and legacy devices 106 may also be referred to as HE stations (STAs) and legacy STAs, respectively. Wireless device 500 may be suitable for operating as access point 102 (FIG. 1), as a HE device 104, as a legacy device 106, and under one or more of the NB, hybrid or NB/hybrid device types (FIG. 1).

In accordance with embodiments, HEW device 500 may include, among other things, a transmit/receive element 501 (for example, an antenna), a transceiver 502, physical layer (PHY) circuitry 504, and media access control (MAC) circuitry 506. PHY 504 and MAC 506 may be HE compliant layers and may also be compliant with one or more legacy IEEE 802.11 standards (such as 802.11 a/g/n/ac). MAC 506 may be arranged to configure device coexistence class (DCC) elements, and arranged to transmit and receive DCC elements, among other things. Wireless device 500 may also include other hardware circuitry 508 and memory 510, both of which may be configured to perform the various operations described herein. The hardware circuitry 508 may be coupled to the transceiver 502, which may be coupled to the transmit/receive element 501. While FIG. 5 depicts the hardware circuitry 508 and the transceiver 502 as separate components, the hardware circuitry 508 and the transceiver 502 may be integrated together in an electronic package or chip.

In example embodiments, the wireless device 500 is configured to perform one or more of the functions and/or methods described herein in conjunction with FIGS. 1-4, such as enabling coexistence with narrowband (NB) Wi-Fi devices through device class definitions.

The PHY 504 may be arranged to transmit the DCC elements in one or more of a control frame, a management frame or a data frame. The PHY 504 may include circuitry for modulation/demodulation, upconversion/downconversion, filtering, amplification, and so forth. In some embodiments, the hardware circuitry 508 may include one or more processors. The hardware circuitry 508 may be configured to perform functions based on instructions being stored in a random access memory (RAM) or read-only memory (ROM), or based on special purpose circuitry. In some embodiments, the hardware circuitry 508 may be configured to perform one or more of the functions and/or methods described herein in conjunction with FIGS. 1-4, such as enabling coexistence with narrowband (NB) Wi-Fi devices through device class definitions.

In some embodiments, two or more antennas may be coupled to the PHY 504 and arranged for sending and receiving signals including transmission of legacy packets, including legacy (wideband) preamble followed by narrowband preamble and narrowband data. The wireless device 500 may include a transceiver 502, to transmit and receive data such as receiving a DCC element indicating that another STA is a NB class device, or transmitting a DCC element indicating that the device 500 is a hybrid or NB/hybrid type device, for example. The memory 510 may store information for configuring the other circuitry to perform operations for one or more of the functions and/or methods described herein for enabling coexistence with narrowband (NB) Wi-Fi devices through device class definitions.

In some embodiments, the wireless device 900 may be configured to communicate in accordance with one or more specific communication standards, such as the IEEE standards, including IEEE 802.11-2012, 802.11n-2009, 802.11ac-2013, 802.11ax, standards and/or proposed specifications for WLANs, although the scope of the example embodiments is not limited in this respect as they may also be suitable to transmit and/or receive communications in accordance with other techniques and standards. In some embodiments, the wireless device 500 may use 4× symbol duration of 802.11n or 802.11ac.

In some embodiments, a wireless device 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, a low-power (LP) device (such as a NB device including a NB sensor device), or other device that may receive and/or transmit information wirelessly using a wideband (e.g., 20 MHz) or narrowband (e.g., 2 MHz) channel bandwidth. In some embodiments, the mobile device may include one or more of a keyboard, a display, a non-volatile memory port, multiple antennas, a graphics processor, an application processor, speakers, and other mobile device elements. The display may be a liquid crystal display (LCD) screen including a touch screen.

The transmit/receive element 501 may comprise one or more directional or omnidirectional antennas, including, for example, dipole antennas, monopole antennas, patch antennas, loop antennas, microstrip antennas or other types of antennas suitable for transmission of radio frequency (RF) signals. In some MIMO embodiments, the antennas may be effectively separated to take advantage of spatial diversity and the different channel characteristics that may result.

Although the device 500 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

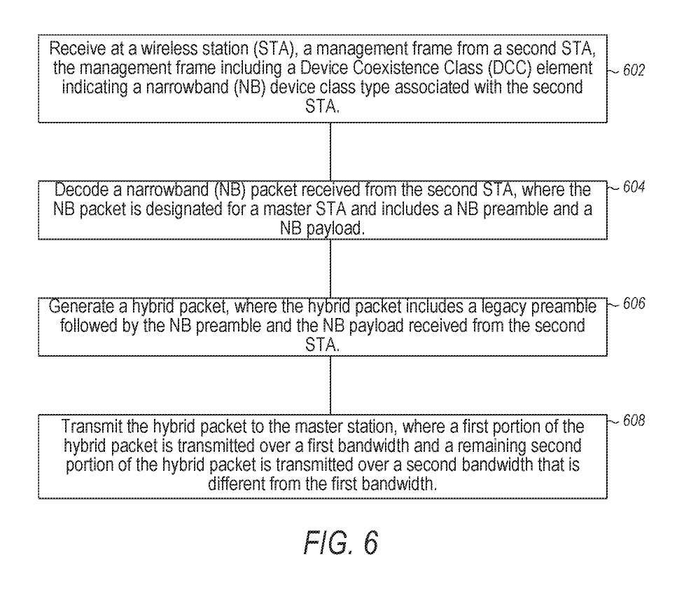

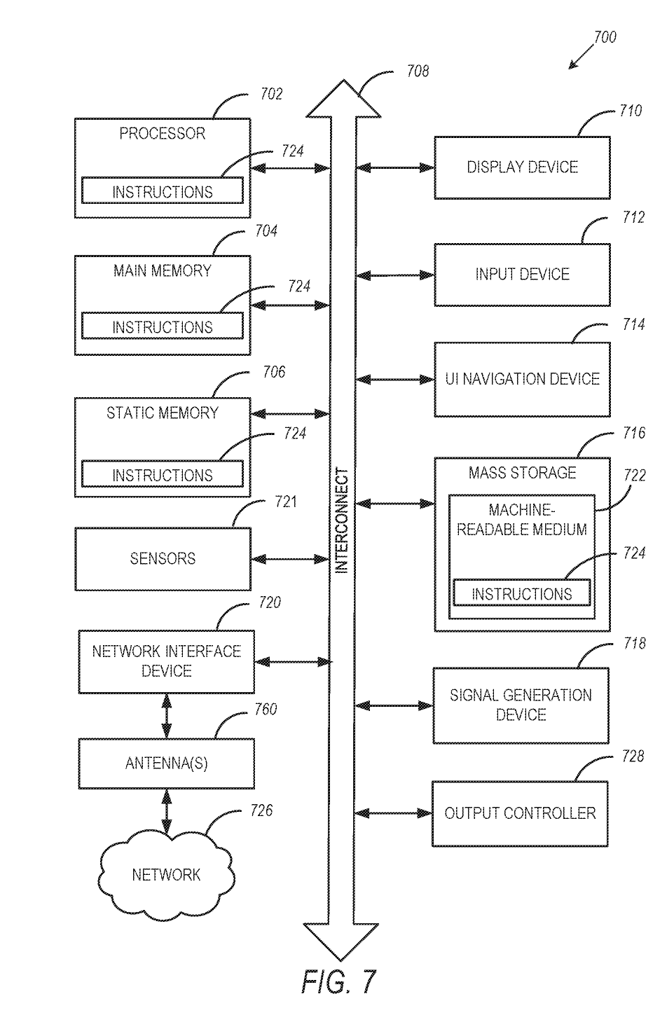

FIG. 6 illustrates a flow diagram of an example method for communication between a NB class device and hybrid class device within a WLAN, in accordance with an example embodiment. Referring to FIG. 6, the example method 600 may start at 602, when a wireless station (STA) (e.g., 104) may receive a management frame from a second STA (e.g., 108). The management frame may include a Device Coexistence Class (DCC) element (e.g., 400) indicating a narrowband (NB) device class type associated with the second STA. For example, the second STA may be a smoke detector and may communicate a DCC element 400 with a device class type field 408 indicating that the smoke detector is a NB class device.

In another example, the STA 104 may receive a management frame (e.g., a beacon frame) with a DCC indicating a hybrid class device for the second STA. The STA 104 may then respond with a hybrid or NB frame.

At 604, a narrowband (NB) packet received from the second STA may be decoded. The NB packet may be designated for a master station and may include a NB preamble and a NB payload. For example, the NB class device smoke detector in FIG. 2) may communicate a NB packet that includes a NB preamble 304 and a NB payload 306. At 606, the wireless STA may generate a hybrid packet. For example, the hybrid class device can receive the NB packet from the NB class device and can generate a hybrid packet 300, which includes a legacy preamble (e.g., 302) followed by the NB preamble (304) and the NB payload (306) received from the second STA. At 608, the hybrid packet can be transmitted to the master station (e.g., AP 102). A first portion of the hybrid packet (e.g., the legacy preamble 302) can be transmitted over a first bandwidth (e.g., 20 MHz bandwidth), and a remaining second portion of the hybrid packet (e.g., the NB preamble 304 and the NB payload 306) may be transmitted over a second bandwidth (e.g., 2 MHz) that is different from the first bandwidth (in different examples, other bandwidth combinations may be used as well).

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Additionally, the machine 700 may be a NB device 108, a hybrid device 110, or a hybrid/NB device 112. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display device 710, an input device 712 (e.g., a keyboard), and a user interface (UI) navigation device 714 (e.g., a mouse). In an example, the display device 710, input device 712 and UI navigation device 714 may be a touch screen display. The machine 700 may additionally include a mass storage (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 702 and/or instructions 724 may comprise processing circuitry and/or transceiver circuitry.

The storage device 716 may include a machine readable medium 722, on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

An apparatus of the machine 700 may be one or more of a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 720 may include one or more physical jacks (e.g., Ethernet, coaxial, or phone jacks) or one or more antennas to connect to the communications network 726. In an example, the network interface device 720 may include one or more antennas 760 to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques. The term “transmission medium” shall be taken to include any intangible medium that is capable of storing, encoding or carrying instructions for execution by the machine 700, and includes digital or analog communications signals or other intangible medium to facilitate communication of such software.

### ADDITIONAL NOTES AND EXAMPLES

Example 1 is an apparatus of a wireless station (STA), the apparatus comprising: memory; and processing circuitry, and configured to communicate in a wireless network, the processing circuitry configured to: decode a packet received from a second STA, the packet comprising an information element (IE) indicating the second STA is one of a hybrid class device or a narrowband (NB) class device; when the IE indicates that the second STA is a hybrid class STA: generate a hybrid packet for transmission to the second STA, the hybrid packet comprising a legacy preamble followed by a narrowband (NB) preamble and a NB payload, wherein the legacy preamble comprises a legacy signal field (L-SIG); and configure the L-SIG to signal a time duration for the hybrid packet transmission; and when the IE indicates that the second STA is a NB class STA: generate a NB packet for transmission to the second STA, the NB packet comprising the NB preamble and the NB payload, the NB packet generated without the legacy preamble, wherein the legacy preamble is configured for transmission over a 20 MHz bandwidth, and wherein the NB preamble and the NB payload are configured for transmission within the 20 MHz bandwidth over a bandwidth that is narrower than 20 MHz.

In Example 2, the subject matter of Example 1 optionally includes MHz.

In Example 3, the subject matter of any one or more of Examples 1-2 optionally include wherein the time duration includes a time for transmitting the hybrid packet to the receiving client station and a time for receiving an acknowledgement from the receiving client station.

In Example 4, the subject matter of any one or more of Examples 1-3 optionally include wherein the processing circuitry is further configured to: generate the NB preamble and the NB payload for transmission on a center frequency of the 20 MHz channel used for transmission of the legacy preamble.

In Example 5, the subject matter of any one or more of Examples 1-4 optionally include wherein the processing circuitry is further configured to: generate the NB preamble and the NB payload for transmission on a frequency that is offset from a center frequency of the 20 MHz channel used for transmission of the legacy preamble.

In Example 6, the subject matter of any one or more of Examples 1-5 optionally include wherein the processing circuitry is further configured to: perform a 20 MHz clear channel assessment (CCA) prior to transmission of the hybrid packet.

In Example 7, the subject matter of any one or more of Examples 1-6 optionally include wherein the processing circuitry is further configured to: prior to generating the hybrid packet, generate a frame for transmission, the frame comprising a Device Coexistence Class (DCC) element indicating a device class type associated with the wireless station.

In Example 8, the subject matter of Example 7 optionally includes wherein the DCC element comprises: an element identification (ID) field indicating an ID for the DCC element; an element ID extension field indicating an extension of the element ID field; a class type field indicating the device class type; and a length field indicating the length of the DCC after the element ID field and including the class type field.

In Example 9, the subject matter of any one or more of Examples 7-8 optionally include wherein the device class type is one of: a hybrid class device indicating a device configured to transmit a legacy preamble followed by a NB preamble and a NB payload; a NB class device indicating a device configured to transmit on a narrowband channel, the NB preamble and the NB payload without the legacy preamble; and a mixed class device indicating a device that can he configured to operate as the hybrid class device or as the NB class device.

In Example 10, the subject matter of any one or more of Examples 7-9 optionally include wherein the frame with the DCC element is a frame of type control, management or actions.

In Example 11, the subject matter of any one or more of Examples 1-10 optionally include transceiver circuitry coupled to the processing circuitry.

In Example 12, the subject matter of Example 11 optionally includes one or more antennas coupled to the transceiver circuitry.

Example 13 is an apparatus of a station (STA), the apparatus comprising: memory; and processing circuitry coupled to the memory, the processing circuity configured to: generate a management frame for transmission, the management frame comprising a Device Coexistence Class (DCC) element indicating a narrowband (NB) device class type associated with the STA; and in response to the management frame transmission, decode a packet received from a second station, the packet comprising a narrowband (NB) preamble followed by a NB payload, wherein the packet is received over a bandwidth that is narrower than 20 MHz and the packet does not include a legacy preamble.

In Example 14, the subject matter of Example 13 optionally includes wherein the processing circuitry is further configured to: decode a management frame received from the second station, the management frame comprising a DCC element indicating a hybrid device class type associated with the second station, wherein the hybrid device class type indicates a wireless station capable of transmitting a legacy preamble over a 20 MHz bandwidth, and the NB preamble and the NB payload over a bandwidth that is narrower than 20 MHz.

In Example 15, the subject matter of any one or more of Examples 13-14 optionally include wherein the processing circuitry is further configured to: encode a NB packet for transmission to the second station, the NB packet comprising a NB preamble followed by a NB payload.

In Example 16, the subject matter of Example 15 optionally includes MHz.

Example 17 is a non-transitory computer-readable storage medium that stores instructions for execution by one or more processors, the instructions to configure the one or more processors to cause a wireless device to: decode a narrowband (NB) packet received from a second wireless device, wherein the NB packet is designated for a master station and includes a NB preamble and a NB payload; generate a hybrid packet, wherein the hybrid packet comprises a legacy preamble followed by the NB preamble and the NB payload received from the second client station; and transmit the hybrid packet to the master station, wherein the legacy preamble is transmitted over a 20 MHz bandwidth, and wherein the NB preamble and the NB payload are transmitted within the 20 MHz bandwidth over a bandwidth that is narrower than 20 MHz.

In Example 18, the subject matter of Example 17 optionally includes wherein the instructions further cause the wireless device to: decode a management frame received from the second client station, the management frame comprising a Device Coexistence Class (DCC) element indicating the second client station is a narrowband (NB) device.

In Example 19, the subject matter of any one or more of Examples 17-18 optionally include wherein the instructions further cause the wireless device to: decode a management frame received from the master station, the management frame comprising a DCC element indicating a hybrid device class type associated with the master station, wherein the hybrid device class type indicates a wireless station capable of transmitting a legacy preamble over a 20 MHz bandwidth, followed by a NB preamble and NB payload over a bandwidth that is narrower than 20 MHz.

Example 20 is a method performed by a wireless station (STA), the method comprising: receiving a management frame from a second STA, the management frame comprising a Device Coexistence Class (DCC) element indicating a narrowband (NB) device class type associated with the second STA; decoding a narrowband (NB) packet received from the second STA, wherein the NB packet is designated for a master station and includes a NB preamble and a NB payload; generating a hybrid packet, wherein the hybrid packet comprises a legacy preamble followed by the NB preamble and the NB payload received from the second STA; and transmitting the hybrid packet to the master station, wherein a first portion of the hybrid packet is transmitted over a first bandwidth and a remaining second portion of the hybrid packet is transmitted over a second bandwidth that is different from the first bandwidth.

In Example 21, the subject matter of Example 20 optionally includes MHz bandwidth, and wherein the NB preamble and the NB payload are transmitted within the 20 MHz bandwidth over a bandwidth that is narrower than 20 MHz.

In Example 22, the subject matter of any one or more of Examples 20-21 optionally include generating a frame for transmission, the frame comprising a DCC element indicating a device class type associated with the wireless station.

In Example 23, the subject matter of Example 22 optionally includes wherein the DCC element comprises: an element identification (ID) field indicating an ID for the DCC element; an element ID extension field indicating an extension of the element ID field; a class type field indicating the device class type associated with the STA; and a length field indicating the length of the DCC after the element ID field and including the class type field.

In Example 24, the subject matter of Example 23 optionally includes wherein the device class type is one of: a hybrid class device indicating a device configured to transmit a legacy preamble followed by a NB preamble and a NB payload; a NB class device indicating a device configured to transmit on a narrowband channel the NB preamble and the NB payload without the legacy preamble; and a mixed class device indicating a device that can be configured to operate as the hybrid class device or as the NB class device.

In Example 25, the subject matter of any one or more of Examples 20-24 optionally include performing 20 MHz clear channel assessment (CCA) prior to transmission of the hybrid packet.

Example 26 is at least one machine-readable medium that, when executed by a machine, causes the machine to perform any of the methods of Examples 20-25.

Example 27 is a device comprising means to perform any of the methods of Examples 20-25.

Example 28 is an apparatus of a wireless device, the apparatus comprising: means for decoding a narrowband (NB) packet received from a second wireless device, wherein the NB packet is designated for a master station and includes a NB preamble and a NB payload; means for generating a hybrid packet, wherein the hybrid packet comprises a legacy preamble followed by the NB preamble and the NB payload received from the second client station; and means for transmitting the hybrid packet to the master station, wherein the legacy preamble is transmitted over a 20 MHz bandwidth, and wherein the NB preamble and the NB payload are transmitted within the 20 MHz bandwidth over a bandwidth that is narrower than 20 MHz.

In Example 29, the subject matter of Example 28 optionally includes means for decoding a management frame received from the second client station, the management frame comprising a Device Coexistence Class (DCC) element indicating the second client station is a narrowband (NB) device.

In Example 30, the subject matter of any one or more of Examples 28-29 optionally include means for decoding a management frame received from the master station, the management frame comprising a DCC element indicating a hybrid device class type associated with the master station, wherein the hybrid device class type indicates a wireless station capable of transmitting a legacy preamble over a 20 MHz bandwidth, followed by a NB preamble and NB payload over a bandwidth that is narrower than 20 MHz.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless station (STA), the apparatus comprising:
memory; and processing circuitry, and configured to communicate in a wireless network, the processing circuitry configured to:
decode a packet received from a second STA, the packet comprising an information element (IE) indicating the second STA is one of a hybrid class device or a narrowband (NB) class device;
when the IE indicates that the second STA is a hybrid class STA:
generate a hybrid packet for transmission to the second STA, the hybrid packet comprising a legacy preamble followed by a narrowband (NB) preamble and a NB payload, wherein the legacy preamble comprises a legacy signal field (L-SIG); and
configure the L-SIG to signal a time duration for the hybrid packet transmission; and
when the IE indicates that the second STA is a NB class STA:
generate a NB packet for transmission to the second STA, the NB packet comprising the NB preamble and the NB payload, the NB packet generated without the legacy preamble,
wherein the legacy preamble is configured for transmission over a 20 MHz bandwidth, and
wherein the NB preamble and the NB payload are configured for transmission within the 20 MHz bandwidth over a bandwidth that is narrower than 20 MHz.

2. The wireless station of claim 1, wherein the bandwidth for transmission of the NB preamble and the NB payload is approximately in the range of 2 MHz-2.6 MHz.

3. The wireless station of claim 1, wherein the time duration includes a time for transmitting the hybrid packet to the receiving client station and a time for receiving an acknowledgement from the receiving client station.

4. The wireless station of claim 1, wherein the processing circuitry is further configured to:
generate the NB preamble and the NB payload for transmission on a center frequency of the 20 MHz channel used for transmission of the legacy preamble.

5. The wireless station of claim 1, wherein the processing circuitry is further configured to:
generate the NB preamble and the NB payload for transmission on a frequency that is offset from a center frequency of the 20 MHz channel used for transmission of the legacy preamble.

6. The wireless station of claim 1, wherein the processing circuitry is further configured to:
perform a 20 MHz clear channel assessment (CCA) prior to transmission of the hybrid packet.

7. The wireless station of claim 1, wherein the processing circuitry is further configured to:
prior to generating the hybrid packet, generate a frame for transmission, the frame comprising a Device Coexistence Class (DCC) element indicating a device class type associated with the wireless station.

8. The wireless station of claim 7, wherein the DCC element comprises:
an element identification (ID) field indicating an ID for the DCC element;
an element ID extension field indicating an extension of the element ID field;
a class type field indicating the device class type; and
a length field indicating the length of the DCC after the element ID field and including the class type field.

9. The wireless station of claim 7, wherein the device class type is one of:
a hybrid class device indicating a device configured to transmit a legacy preamble followed by a NB preamble and a NB payload;
a NB class device indicating a device configured to transmit on a narrowband channel, the NB preamble and the NB payload without the legacy preamble; and
a mixed class device indicating a device that can be configured to operate as the hybrid class device or as the NB class device.

10. The wireless station of claim 7, wherein the frame with the DCC element is a frame of type control, management or actions.

11. The wireless station of claim 1, further comprising transceiver circuitry coupled to the processing circuitry.

12. The wireless station of claim 11, further comprising one or more antennas coupled to the transceiver circuitry.

13. An apparatus of a station (STA), the apparatus comprising: memory; and processing circuitry coupled to the memory, the processing circuity configured to:
generate a management frame for transmission, the management frame comprising a Device Coexistence Class (DCC) element indicating a narrowband (NB) device class type associated with the STA; and
in response to the management frame transmission, decode a packet received from a second station, the packet comprising a narrowband (NB) preamble followed by a NB payload,
wherein the packet is received over a bandwidth that is narrower than 20 MHz and the packet does not include a legacy preamble.

14. The wireless station of claim 13, wherein the processing circuitry is further configured to:
decode a management frame received from the second station, the management frame comprising a DCC element indicating a hybrid device class type associated with the second station,
wherein the hybrid device class type indicates a wireless station capable of transmitting a legacy preamble over a 20 MHz bandwidth, and the NB preamble and the NB payload over a bandwidth that is narrower than 20 MHz.

15. The wireless station of claim 13, wherein the processing circuitry is further configured to:
encode a NB packet for transmission to the second station, the NB packet comprising a NB preamble followed by a NB payload.

16. The wireless station of claim 15, wherein a bandwidth for transmission of the NB preamble and the NB payload to the second station is approximately in the range of 2 MHz-2.6 MHz.

17. A non-transitory computer-readable storage medium that stores instructions for execution by one or more processors, the instructions to configure the one or more processors to cause a wireless device to:
decode a narrowband (NB) packet received from a second wireless device, wherein the NB packet is designated for a master station and includes a NB preamble and a NB payload;
generate a hybrid packet, wherein the hybrid packet comprises a legacy preamble followed by the NB preamble and the NB payload received from the second client station; and
transmit the hybrid packet to the master station,
wherein the legacy preamble is transmitted over a 20 MHz bandwidth, and
wherein the NB preamble and the NB payload are transmitted within the 20 MHz bandwidth over a bandwidth that is narrower than 20 MHz.

18. The computer-readable storage medium of claim 17, wherein the instructions further cause the wireless device to:
decode a management frame received from the second client station, the management frame comprising a Device Coexistence Class (DCC) element indicating the second client station is a narrowband (NB) device.

19. The computer-readable storage medium of claim 17, wherein the instructions further cause the wireless device to:
decode a management frame received from the master station, the management frame comprising a DCC element indicating a hybrid device class type associated with the master station,
wherein the hybrid device class type indicates a wireless station capable of transmitting a legacy preamble over a 20 MHz bandwidth, followed by a NB preamble and NB payload over a bandwidth that is narrower than 20 MHz.

20. A method performed by a wireless station (STA), the method comprising:
receiving a management frame from a second STA, the management frame comprising a Device Coexistence Class (DCC) element indicating a narrowband (NB) device class type associated with the second STA;
decoding a narrowband (NB) packet received from the second STA, wherein the NB packet is designated for a master station and includes a NB preamble and a NB payload;
generating a hybrid packet, wherein the hybrid packet comprises a legacy preamble followed by the NB preamble and the NB payload received from the second STA; and
transmitting the hybrid packet to the master station, wherein a first portion of the hybrid packet is transmitted over a first bandwidth and a remaining second portion of the hybrid packet is transmitted over a second bandwidth that is different from the first bandwidth.

21. The method according to claim 20, wherein the legacy preamble is transmitted over a 20 MHz bandwidth, and
wherein the NB preamble and the NB payload are transmitted within the 20 MHz bandwidth over a bandwidth that is narrower than 20 MHz.

22. The method according to claim 20, further comprising:
generating a frame for transmission, the frame comprising a DCC element indicating a device class type associated with the wireless station.

23. The method according to claim 22, wherein the DCC element comprises:
an element identification (ID) field indicating an ID for the DCC element;
an element ID extension field indicating an extension of the element ID field;
a class type field indicating the device class type associated with the STA; and
a length field indicating the length of the DCC after the element ID field and including the class type field.

24. The method according to claim 23, wherein the device class type is one of:
a hybrid class device indicating a device configured to transmit a legacy preamble followed by a NB preamble and a NB payload;
a NB class device indicating a device configured to transmit on a narrowband channel the NB preamble and the NB payload without the legacy preamble; and
a mixed class device indicating a device that can be configured to operate as the hybrid class device or as the NB class device.

25. The method according to claim 20, further comprising:
performing 20 MHz clear channel assessment (CCA) prior to transmission of the hybrid packet.
